(19) United States
(12) Patent Application Publication
(10) Pub. No.: US 2023/0327076 A1
(43) Pub. Date: Oct. 12, 2023

(54) LITHIUM ION BATTERY WITH COMPOSITE ELECTRODES

(71) Applicant: Google LLC, Mountain View, CA (US)

(72) Inventors: Taisup Hwang, Santa Clara, CA (US); Ramesh C. Bhardwaj, Fremont, CA (US); Lei Cao, San Jose, CA (US); Dookyoung Lee, Campbell, CA (US); Qiang Luo, Milpitas, CA (US)

(21) Appl. No.: 18/008,847

(22) PCT Filed: Dec. 17, 2021
(86) PCT No.: PCT/US2021/064225

§ 371 Date: Dec. 7, 2022

(51) Int. Cl. H01M 4/133; H01M 10/0525; H01M 4/587; H01M 4/38; H01M 4/62; H01M 4/525; H01M 10/0569; H01M 10/0567; H01M 4/131

(52) U.S. Cl. CPC H01M 4/133; H01M 10/0525; H01M 4/587; H01M 4/386; H01M 4/622; H01M 4/525; H01M 4/625; H01M 10/0569; H01M 10/0567; H01M 4/131; H01M 2300/0034; H01M 2300/0042

(57) ABSTRACT

Composite lithium ion batteries having an anode with an anode collector and a composite anode material, a cathode with a cathode collector and a composite cathode material, a separator positioned between the anode and the cathode, and an electrolyte in contact with the anode and the cathode. Advantages of the composite lithium ion batteries include lower DC impedance, faster charging times, more reserve capacity between 3.0V and 2.5V, and an increased volumetric energy density relative to lithium ion batteries that do not include the described composite material electrodes.

### CROSS-REFERENCE TO RELATED APPLICATION

This application claims the benefit of U.S. Patent Application No. 63/218,193 entitled “LITHIUM ION BATTERY WITH COMPOSITE ELECTRODES” and filed on Jul. 2, 2021, which is incorporated herein by reference in its entirety.

### TECHNICAL FIELD

This invention relates to a lithium ion battery with a composite anode, a composite cathode, and an organic solvent based electrolyte.

### BACKGROUND

FIG. 1 depicts lithium ion battery 100 having anode 102 and cathode 104. Anode 102 and cathode 104 are separated by separator 106. Anode 102 includes anode collector 108 and anode material 110 in contact with the anode collector. Cathode 104 includes cathode collector 112 and cathode material 114 in contact with the cathode collector. Electrolyte 116 is in contact with anode material 110 and cathode material 114. Anode collector 108 and cathode collector 112 are electrically coupled via closed external circuit 118. Anode material 110 and cathode material 114 are materials into which, and from which, lithium ions 120 can migrate. During insertion (or intercalation) lithium ions move into the electrode (anode or cathode) material. During extraction (or deintercalation), the reverse process, lithium ions move out of the electrode (anode or cathode) material. When an electrochemical device is discharging, lithium ions are extracted from the anode material and inserted into the cathode material. When the cell is charging, lithium ions are extracted from the cathode material and inserted into the anode material. The arrows in FIG. 1 depict movement of lithium ions through separator 106 during charging and discharging.

### SUMMARY

This disclosure generally relates to a lithium ion battery that includes electrodes made from composite material. The composite anode material includes graphite, SiOx, and a binder. The composite cathode material includes LiCoO₂, one or both of graphene and carbon nanostructures (e.g., carbon nanotubes), and a binder.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a lithium ion battery comprising:
an anode comprising an anode collector and a composite anode material;
a cathode comprising a cathode collector and a composite cathode material;
a separator positioned between the anode and the cathode; and
an electrolyte in contact with the anode and the cathode.

Embodiment 2 is a lithium ion battery of embodiment 1, wherein the composite anode material comprises 75 wt % to 95 wt % graphite, 2 wt % to 20 wt % SiOx, and 0.1 wt % to 10 wt % binder.

Embodiment 3 is a lithium ion battery of embodiment 2, wherein the composite anode material comprises 0.1 wt % to 10 wt % conductive additive.

Embodiment 4 is a lithium ion battery of embodiment 3, wherein the composite anode material comprises 80 wt % to 90 wt % graphite, 5 wt % to 10 wt % SiOx, 0.1 wt % to 5 wt % binder, and 0.1 wt % to 2 wt % conductive additive.

Embodiment 5 is a lithium ion battery of embodiments 3 or 4, wherein the composite anode material comprises 86 wt % to 87 wt % graphite, 9 wt % to 10 wt % SiOx, 2 wt % to 3 wt % binder, and 0.5 wt % to 1.5 wt % conductive additive, and the binder is a mixture of CMC and PAA in a weight ratio of about 1 to 4.

Embodiment 6 is a lithium ion battery of embodiment 5, wherein the composite anode material comprises 86.7 wt % graphite, 9.6 wt % SiOx, 2.7 wt % binder, and 1 wt % conductive additive, and the binder is a mixture of CMC and PAA in a weight ratio of 0.5:2.2.

Embodiment 7 is a lithium ion battery of any one of embodiments 3 through 6, wherein the composite anode material comprises 75 wt % to 85 wt % graphite, 10 wt % to 20 wt % SiOx, 0.1 wt % to 5 wt % binder, and 0.5 wt % to 2.5 wt % conductive additive.

Embodiment 8 is a lithium ion battery of embodiment 7, wherein the composite anode material comprises 79 wt % to 81 wt % graphite, 14 wt % to 16 wt % SiOx, 3 wt % to 4 wt % binder, and 1 wt % to 2 wt % conductive additive, and the binder is a mixture of CMC and PAA in a weight ratio of about 1 to 6.

Embodiment 9 is a lithium ion battery of embodiment 8, wherein the composite anode material comprises 80 wt % graphite, 15 wt % SiOx, 3.5 wt % binder, and 1.5 wt % conductive additive, and the binder is a mixture of CMC and PAA in a weight ratio of 0.5:3.0.

Embodiment 10 is a lithium ion battery of any one of embodiments 3 through 9, wherein the composite anode material comprises 85 wt % to 95 wt % graphite, 1 wt % to 10 wt % SiOx, 0.1 wt % to 5 wt % binder, and 0.1 wt % to 2 wt % conductive additive.

Embodiment 11 is a lithium ion battery of embodiment 10, wherein the composite anode material comprises 91 wt % to 93 wt % graphite, 4 wt % to 6 wt % SiOx, 2 wt % to 3 wt % binder, and 0.5 wt % to 1 wt % conductive additive, and the binder is a mixture of CMC and PAA in a weight ratio of about 1 to 3.

Embodiment 12 is a lithium ion battery of embodiment 11, wherein the composite anode material comprises 92 wt % graphite, 5 wt % SiOx, 2.3 wt % binder, and 0.7 wt % conductive additive, and the binder is a mixture of CMC and PAA in a weight ratio of 0.5:1.8.

Embodiment 13 is a lithium ion battery of any one of embodiments 3 through 12, wherein the composite cathode material comprises 90 wt % to 99 wt % LiCoO₂, 0.1 wt % to 2 wt % binder, and 0.1 wt % to 2 wt % graphene, carbon nanostructures, or a combination thereof.

Embodiment 14 is a lithium ion battery of embodiment 13, wherein the binder comprises polyvinylidene fluoride (PVDF).

Embodiment 15 is a lithium ion battery of embodiment 14, wherein the composite cathode material comprises 0.1 wt % to 10 wt % conductive additive.

Embodiment 16 is a lithium ion battery of any one of embodiments 13 through 15, wherein the composite cathode material comprises 95 wt % to 99 wt % LiCoO₂, 1 wt % to 2 wt % binder, and 0.1 wt % to 1 wt % graphene, carbon nanostructures, or a combination thereof.

Embodiment 17 is a lithium ion battery of embodiment 16, wherein the composite cathode material comprises 97 wt % to 98 wt % LiCoO₂, 1 wt % to 2 wt % binder, and 0.56 wt % graphene paste, carbon nanostructures, or a combination thereof.

Embodiment 18 is a lithium ion battery of embodiments 16 or 17, wherein the composite cathode material comprises 97.72 wt % LiCoO₂, 1.5 wt % PVDF, and 0.5 wt % graphene paste and carbon nanotubes.

Embodiment 19 is a lithium ion battery of any one of embodiments 16 through 18, wherein the composite cathode material comprises 97.76 wt % LiCoO₂, 1.5 wt % PVDF, and 0.5 wt % carbon nanotubes.

Embodiment 20 is a lithium ion battery of any one of embodiments 16 through 19, wherein the composite cathode material comprises 97.76 wt % LiCoO₂, 1.5 wt % PVDF, 0.5 wt % carbon nanotubes, and 0.005 wt % graphene. I

[symbol]

Embodiment 21 is a lithium ion battery of any one of embodiments 16 through 20 , wherein the composite cathode material comprises 97.94 wt % LiCoO₂, 1.2 wt % PVDF, 0.06 wt % single-walled carbon nanotubes, and 0.5 wt % carbon black.

Embodiment 22 is a lithium ion battery of any one of embodiments 13 through 21, wherein the electrolyte is a liquid organic solvent-based electrolyte comprising one or more of fluoroethylene carbonate (FEC), propylene carbonate (PC), diethyl carbonate (DC), polypropylene (PC), and polypropylene (PP) in a lithium hexafluorophosphate (LiPF₆) solution comprising one or more of adiponitrile (ADN), succinonitrile (SN), 1,3-propane sultone (PS), and vinylene carbonate (VC).

Embodiment 23 is a lithium ion battery of embodiment 22, wherein the electrolyte comprises one or more organosilicon additives.

Embodiment 24 is a lithium ion battery of one of embodiments 13 through 23, wherein the electrolyte is comprises 0 vol % to 20 vol % FEC, 0 vol % to 20 vol % PC, 0 vol % to 40 vol % EC, 0 vol % to 40 vol % DEC, and 0 vol % to 50 vol % PP.

Embodiment 25 is a lithium ion battery of any one of embodiments 22 through 24, wherein the LiPF₆ solution has a concentration in a range of 0.1M to 5M, 0.5M to 1.5M, or about 1M.

Embodiment 26 is a lithium ion battery of any one of embodiments 22 through 25 , wherein the LiPF₆ solution comprises 0.1 wt % to 5 wt %, 0.1 wt % to 4 wt %, 0.1 wt % to 3 wt % one or more of ADN, SN, PS, VC, and OS3.

Embodiment 27 is a lithium ion battery of any one of embodiments 22 through 26, wherein the electrolyte comprises FEC, PC, DC, PC, and PP in a LiPF₆ solution comprising ADN, SN, PS, VC, and OS3.

Embodiment 28 is a lithium ion battery of embodiment 27, wherein the electrolyte comprises 1 vol % to 20 vol % FEC, 5 vol % to 15 vol % PC, 5 vol % to 15 vol % EC, 15 vol % to 25 vol % DEC, and 30 vol % to 45 vol % PP.

Embodiment 29 is a lithium ion battery of embodiment 27 or 28, wherein the electrolyte comprises 5 vol % to 10 vol % FEC, 5 vol % to 15 vol % PC, 15 vol % to 25 vol % EC, 20 vol % to 30 vol % DEC, and 30 vol % to 40 vol % PP.

Embodiment 30 is a lithium ion battery of one of embodiments 27 through 29, wherein the electrolyte comprises 5 vol % to 10 vol % FEC, 5 vol % to 10 vol % PC, 15 vol % to 20 vol % EC, 25 vol % to 30 vol % DEC, and 35 vol % to 40 vol % PP.

Embodiment 31 is lithium ion battery of any one of embodiments 27 through 30, wherein the electrolyte comprises 6 vol % to 8 vol % FEC, 8 vol % to 10 vol % PC, 18 vol % to 20 vol % EC, 27 vol % to 29 vol % DEC, and 36 vol % to 38 vol % PP.

Embodiment 32 is a lithium ion battery of embodiment 31, wherein the electrolyte comprises 7 vol % FEC, 9 vol % PC, 19 vol % EC, 28 vol % DEC, and 37 vol % PP.

Embodiment 33 is a lithium ion battery of any one of embodiments 27 through 32, wherein the electrolyte comprises 10 vol % to 20 vol % FEC, 5 vol % to 15 vol % PC, 5 vol % to 15 vol % EC, 25 vol % to 35 vol % DEC, and 35 vol % to 45 vol % PP.

Embodiment 34 is a lithium ion battery of embodiment 33, wherein the electrolyte comprises 14 vol % to 16 vol % FEC, 8 vol % to 10 vol % PC, 9 vol % to 11 vol % EC, 28 vol % to 30 vol % DEC, and 36 vol % to 38 vol %.

Embodiment 35 is a lithium ion battery of embodiment 34, wherein the electrolyte comprises 15 vol % FEC, 9 vol % PC, 10 vol % EC, 29 vol % DEC, and 37 vol % PP.

Embodiment 36 is a lithium ion battery of any one of embodiments 27 through 35, wherein the electrolyte comprises 1 vol % to 10 vol % FEC, 5 vol % to 15 vol % PC, 15 vol % to 25 vol % EC, 25 vol % to 35 vol % DEC, and 30 vol % to 40 vol % PP.

Embodiment 37 is a lithium ion battery of embodiment 36, wherein the electrolyte comprises 1 vol % to 5 vol % FEC, 5 vol % to 10 vol % PC, 20 vol % to 25 vol % EC, 25 vol % to 30 vol % DEC, and 35 vol % to 40 vol % PP.

Embodiment 38 is a lithium ion battery of embodiment 37, wherein the electrolyte comprises 3 vol % FEC, 9 vol % PC, 22 vol % EC, 29 vol % DEC, and 37 vol % PP.

Embodiment 39 is a lithium ion battery of any one of embodiments 26 through 38, wherein the LiPF₆ solution has a concentration in a range of 0.5M to 1.5M and comprises 0.1 wt % to 5 wt % ADN, 0.1 wt % to 5 wt % SN, 0.1 wt % to 5 wt % PS, 0.1 wt % to 5 wt % VC, and 0.1 wt % to 5 wt % organosilicon additive.

Embodiment 40 is a lithium ion battery of embodiment 39, wherein the LiPF₆ solution has a concentration in a range of 0.5M to 1.5M and comprises 0.5 wt % to 1.5 wt % ADN, 0.5 wt % to 1.5 wt % SN, 1 wt % to 3 wt % PS, 0.5 wt % to 1.5 wt % VC, and 1 wt % to 3 wt % organosilicon additive.

Embodiment 41 is a lithium ion battery of embodiment 40, wherein the LiPF₆ solution has a concentration of 1M and comprises 1 wt % ADN, 1 wt % SN, 2 wt % PS, 1 wt % VC, and 2 wt % organosilicon additive.

Embodiment 42 is a lithium ion battery of any of embodiments 26 through 41, wherein the LiPF₆ solution has a concentration in a range of 0.5M to 1.5M and comprises 1 wt % to 3 wt % ADN, 1 wt % to 3 wt % SN, 2 wt % to 4 wt % PS, 0.5 wt % to 1.5 wt % VC, and 1 wt % to 3 wt % organosilicon additive.

Embodiment 43 is a lithium ion battery of embodiment 42, wherein the LiPF₆ solution has a concentration of 1M and comprises 2 wt % ADN, 2 wt % SN, 3 wt % PS, 2 wt % VC, and 3 wt % organosilicon additive.

Embodiment 44 is a lithium ion battery of any of embodiments 26 through 43, wherein the LiPF₆ solution has a concentration in a range of 0.5M to 1.5M and comprises 0.1 wt % to 1 wt % ADN, 0.1 wt % to 1 wt % SN, 0.5 wt % to 1.5 wt % PS, 0.1 wt % to 1 wt % VC, and 1 wt % to 3 wt % organosilicon additive.

Embodiment 45 is a lithium ion battery of embodiment 44, wherein the LiPF₆ solution has a concentration of 1M and comprises 0.5 wt % ADN, 0.5 wt % SN, 1 wt % PS, 0.5 wt % VC, and 1 wt % organosilicon additive.

Embodiment 46 is a wearable product comprising the lithium ion battery of any one of embodiments 1 through 45.

Advantages of the disclosed composite lithium ion batteries include lower DC impedance, faster charging times, more reserve capacity between 3.0V and 2.5V, and an increased volumetric energy density relative to lithium ion batteries that do not include the described composite material electrodes.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 depicts a lithium ion battery.

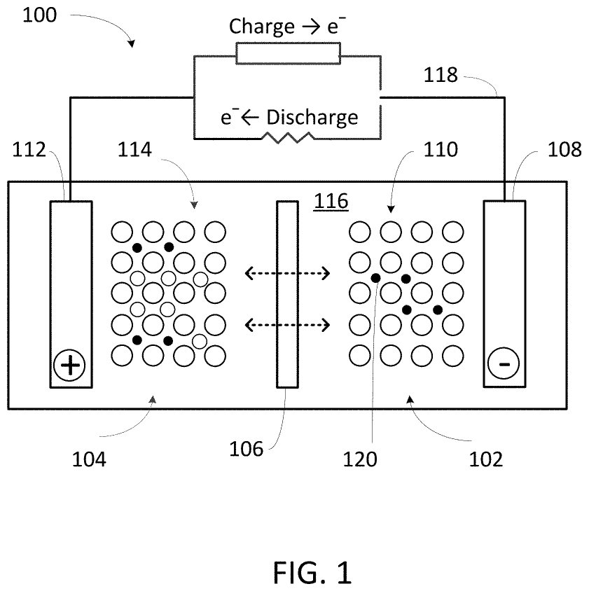

FIG. 2 is a flow chart showing an electrode process flow.

FIG. 3 is a flow chart showing a pouch process flow.

FIG. 4 shows discharge curves for composite electrode batteries and conventional electrode batteries.

FIG. 5 shows relative volumetric energy density (VED) for composite electrode batteries and conventional electrode batteries.

FIG. 6 shows direct current internal resistances (DCIR) of composite electrodes batteries and conventional electrode batteries.

FIG. 7 shows charge time profile of a composite electrode battery and a conventional electrode battery.

FIG. 8 shows cycle performance of composite electrode batteries at 25 degrees C.

FIG. 9 shows cycle performance of composite electrode batteries at 45 degrees C.

FIG. 10 shows cell cycle performance of composite electrode batteries and conventional 4.45V Li-ion batteries at 25 degrees C.

FIG. 11 shows cell cycle performance of composite electrode batteries and conventional 4.45V Li-ion batteries at 45 degrees C.

FIG. 12 shows over-discharge-voltage versus time for composite electrode batteries and conventional electrode batteries.

FIG. 13 shows retaining capacity and recovery capacity of composite electrode batteries at elevated temperature (85 degrees C.).

FIG. 14 shows short term sustainability of batteries as a function of time.

### DETAILED DESCRIPTION

This disclosure describes a lithium ion battery with an anode including a composite anode material, a cathode including a composite cathode material, and an electrolyte. The composite anode material includes graphite, SiOx, and a binder. The composite cathode material includes LiCoO₂, one or both of graphene and carbon nanostructures (e.g., carbon nanotubes), and a binder. The electrolyte is an organic solvent-based electrolyte. A separator (e.g., a polyolefin-based separator) is positioned between the anode and the cathode, and the electrolyte is in contact with the anode and the cathode. The anode material, the cathode material, and the electrolyte can include one or more additives (e.g., a conductive additive).

The composite anode material typically includes 75 wt % to 95 wt % graphite, 2 wt % to 20 wt % SiOx, and 0.1 wt % to 10 wt % binder. The binder can include one or both of polyacrylic acid (PAA) and carboxymethyl cellulose (CMC). In some implementations, the composite anode material includes 0.1 wt % to 10 wt % one or more additives, such as a conductive additive (e.g., a carbon black).

In some implementations, the composite anode material includes 80 wt % to 90 wt % graphite, 5 wt % to 10 wt % SiOx, 0.1 wt % to 5 wt % binder, and 0.1 wt % to 2 wt % conductive additive. In some implementations, the composite anode material includes 86 wt % to 87 wt % graphite, 9 wt % to 10 wt % SiOx, 2 wt % to 3 wt % binder, and 0.5 wt % to 1.5 wt % conductive additive, where the binder is a mixture of CMC and PAA in a weight ratio of about 1 to 4, and the conductive additive is SUPER-P carbon black (available from TIMCAL). In one example, the composite anode material includes 86.7 wt % graphite, 9.6 wt % SiOx, 2.7 wt % binder, and 1 wt % conductive additive. The binder is a mixture of CMC and PAA in a weight ratio of 0.5:2.2, and the conductive additive is SUPER-P carbon black.

In some implementations, the composite anode material includes 75 wt % to 85 wt % graphite, 10 wt % to 20 wt % SiOx, 0.1 wt % to 5 wt % binder, and 0.5 wt % to 2.5 wt % conductive additive. In some implementations, the composite anode material includes 79 wt % to 81 wt % graphite, 14 wt % to 16 wt % SiOx, 3 wt % to 4 wt % binder, and 1 wt % to 2 wt % conductive additive, where the binder is a mixture of CMC and PAA in a weight ratio of about 1 to 6, and the conductive additive is SUPER-P carbon black. In one example, the composite anode material includes 80 wt % graphite, 15 wt % SiOx, 3.5 wt % binder, and 1.5 wt % conductive additive. The binder is a mixture of CMC and PAA in a weight ratio of 0.5:3.0, and the conductive additive is SUPER-P carbon black.

In some implementations, the composite anode material includes 85 wt % to 95 wt % graphite, 1 wt % to 10 wt % SiOx, 0.1 wt % to 5 wt % binder, and 0.1 wt % to 2 wt % conductive additive. In some implementations, the composite anode material includes 91 wt % to 93 wt % graphite, 4 wt % to 6 wt % SiOx, 2 wt % to 3 wt % binder, and 0.5 wt % to 1 wt % conductive additive, where the binder is a mixture of CMC and PAA in a weight ratio of about 1 to 3, and the conductive additive is SUPER-P carbon black. In one example, the composite anode material includes 92 wt % graphite, 5 wt % SiOx, 2.3 wt % binder, and 0.7 wt % conductive additive. The binder is a mixture of CMC and PAA in a weight ratio of 0.5:1.8, and the conductive additive is SUPER-P carbon black.

The composite cathode material typically includes 90 wt % to 99 wt % LiCoO₂, 0.1 wt % to 2 wt % binder, and 0.1 wt % to 2 wt % graphene, carbon nanostructures, or a combination thereof. One example of a suitable binder is polyvinylidene fluoride (PVDF). In some implementations, the composite cathode material includes 0.1 wt % to 10 wt % one or more additives, such as a conductive additive (e.g., a carbon black).

In some implementations, the composite cathode material includes 95 wt % to 99 wt % LiCoO₂, 1 wt % to 2 wt % binder, and 0.1 wt % to 1 wt % graphene, carbon nanostructures, or a combination thereof. In some implementations, the composite cathode material includes 97 wt % to 98 wt % LiCoO₂, 1 wt % to 2 wt % binder, and 0.56 wt % graphene paste, carbon nanostructures, or a combination thereof. In one example, the composite cathode material includes 97.72 wt % LiCoO₂, 1.5 wt % PVDF, and 0.5 wt % graphene paste and carbon nanotubes. In another example, the composite cathode material includes 97.76 wt % LiCoO₂, 1.5 wt % PVDF, and 0.5 wt % carbon nanotubes. In another example, the composite cathode material includes 97.76 wt % LiCoO₂, 1.5 wt % PVDF, 0.5 wt % carbon nanotubes, and 0.005 wt % graphene. In another example, the composite cathode material includes 97.94 wt % LiCoO₂, 1.2 wt % PVDF, 0.06 wt % single-walled carbon nanotubes, and 0.5 wt % SUPER-P carbon black.

The electrolyte is a liquid organic solvent-based electrolyte that includes one or more of fluoroethylene carbonate (FEC), propylene carbonate (PC), diethyl carbonate (DC), polypropylene (PC), and polypropylene (PP) in a lithium hexafluorophosphate (LiPF₆) solution with one or more of adiponitrile (ADN), succinonitrile (SN), 1,3-propane sultone (PS), and vinylene carbonate (VC). In some implementations, the electrolyte includes one or more organosilicon additives, such as OS3 (available from SILATRONIX). The electrolyte can include 0 vol % to 20 vol % FEC, 0 vol % to 20 vol % PC, 0 vol % to 40 vol % EC, 0 vol % to 40 vol % DEC, and 0 vol % to 50 vol % PP. The LiPF₆ solution can have a concentration in a range of 0.1M to 5M, 0.5M to 1.5M, or about 1M. The LiPF₆ solution can include 0.1 wt % to 5 wt %, 0.1 wt % to 4 wt %, 0.1 wt % to 3 wt % one or more of ADN, SN, PS, VC, and OS3.

In some implementations, the electrolyte includes FEC, PC, DC, PC, and PP in a LiPF₆ solution that includes ADN, SN, PS, VC, and OS3. In some implementations, the electrolyte includes 1 vol % to 20 vol % FEC, 5 vol % to 15 vol % PC, 5 vol % to 15 vol % EC, 15 vol % to 25 vol % DEC, and 30 vol % to 45 vol % PP.

In some implementations, the electrolyte includes 5 vol % to 10 vol % FEC, 5 vol % to 15 vol % PC, 15 vol % to 25 vol % EC, 20 vol % to 30 vol % DEC, and 30 vol % to 40 vol % PP. In some implementations, the electrolyte includes 5 vol % to 10 vol % FEC, 5 vol % to 10 vol % PC, 15 vol % to 20 vol % EC, 25 vol % to 30 vol % DEC, and 35 vol % to 40 vol % PP. In some implementations, the electrolyte includes 6 vol % to 8 vol % FEC, 8 vol % to 10 vol % PC, 18 vol % to 20 vol % EC, 27 vol % to 29 vol % DEC, and 36 vol % to 38 vol % PP. In one example, the electrolyte includes 7 vol % FEC, 9 vol % PC, 19 vol % EC, 28 vol % DEC, and 37 vol % PP.

In some implementations, the electrolyte includes 10 vol % to 20 vol % FEC, 5 vol % to 15 vol % PC, 5 vol % to 15 vol % EC, 25 vol % to 35 vol % DEC, and 35 vol % to 45 vol % PP. In some implementations, the electrolyte includes 14 vol % to 16 vol % FEC, 8 vol % to 10 vol % PC, 9 vol % to 11 vol % EC, 28 vol % to 30 vol % DEC, and 36 vol % to 38 vol %. In one example, the electrolyte includes 15 vol % FEC, 9 vol % PC, 10 vol % EC, 29 vol % DEC, and 37 vol % PP.

In some implementations, the electrolyte includes 1 vol % to 10 vol % FEC, 5 vol % to 15 vol % PC, 15 vol % to 25 vol % EC, 25 vol % to 35 vol % DEC, and 30 vol % to 40 vol % PP. In some implementations, the electrolyte includes 1 vol % to 5 vol % FEC, 5 vol % to 10 vol % PC, 20 vol % to 25 vol % EC, 25 vol % to 30 vol % DEC, and 35 vol % to 40 vol % PP. In one example, the electrolyte includes 3 vol % FEC, 9 vol % PC, 22 vol % EC, 29 vol % DEC, and 37 vol % PP.

In some implementations, the LiPF6 solution has a concentration in a range of 0.5M to 1.5M and includes 0.1 wt % to 5 wt % ADN, 0.1 wt % to 5 wt % SN, 0.1 wt % to 5 wt % PS, 0.1 wt % to 5 wt % VC, and 0.1 wt % to 5 wt % OS3. In some implementations, the LiPF₆ solution has a concentration in a range of 0.5M to 1.5M and includes 0.5 wt % to 1.5 wt % ADN, 0.5 wt % to 1.5 wt % SN, 1 wt % to 3 wt % PS, 0.5 wt % to 1.5 wt % VC, and 1 wt % to 3 wt % OS3. In one example, the LiPF₆ solution has a concentration of 1M and includes 1 wt % ADN, 1 wt % SN, 2 wt % PS, 1 wt % VC, and 2 wt % OS3. In some implementations, the LiPF₆ solution has a concentration in a range of 0.5M to 1.5M and includes 1 wt % to 3 wt % ADN, 1 wt % to 3 wt % SN, 2 wt % to 4 wt % PS, 0.5 wt % to 1.5 wt % VC, and 1 wt % to 3 wt % OS3. In one example, the LiPF₆ solution has a concentration of 1M and includes 2 wt % ADN, 2 wt % SN, 3 wt % PS, 2 wt % VC, and 3 wt % OS3. In some implementations, the LiPF₆ solution has a concentration in a range of 0.5M to 1.5M and includes 0.1 wt % to 1 wt % ADN, 0.1 wt % to 1 wt % SN, 0.5 wt % to 1.5 wt % PS, 0.1 wt % to 1 wt % VC, and 1 wt % to 3 wt % OS3. In one example, the LiPF₆ solution has a concentration of 1M and includes 0.5 wt % ADN, 0.5 wt % SN, 1 wt % PS, 0.5 wt % VC, and 1 wt % OS_{3.}

The anode material is selected to achieve a high energy density, and the cathode material is selected to reduce impedance for faster charging and discharging. The electrolyte provides high temperature stability (e.g., to 85° C.). The lithium ion battery has a cycle capability that exceeds 500 cycles with less than 10% swelling. A reserved capacity less than 3 V allows for long-term storage performance. The lithium ion battery can be assembled in a variety of configurations, such as an aluminum laminated composite pouch, a cylindrical cell, a prismatic cell, and a button or coin cell for use in wearable products.

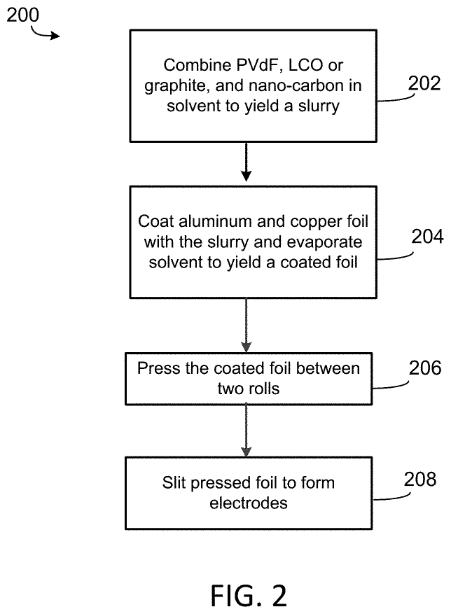

FIG. 2 describes an electrode process flow 200. In 202, poly(vinylidene fluoride) (PVdF), lithium cobalt oxide (LCO) or graphite, and nano-carbon are combined in a solvent (e.g., N-methyl-2-pryrrolidone (NMP)) in calculated amounts and mixed to yield a slurry. Suitable types of nano-carbons include. carbon nanotubes, graphene, and carbon black. In 204, aluminum foil and copper foil, for cathodes and anodes, respectively, are coated with the slurry and the solvent is allowed to evaporate, thereby yielding a coated foil. In 206, the coated foil is pressed between two rolls. In 208, the pressed foil is slit to form electrodes.

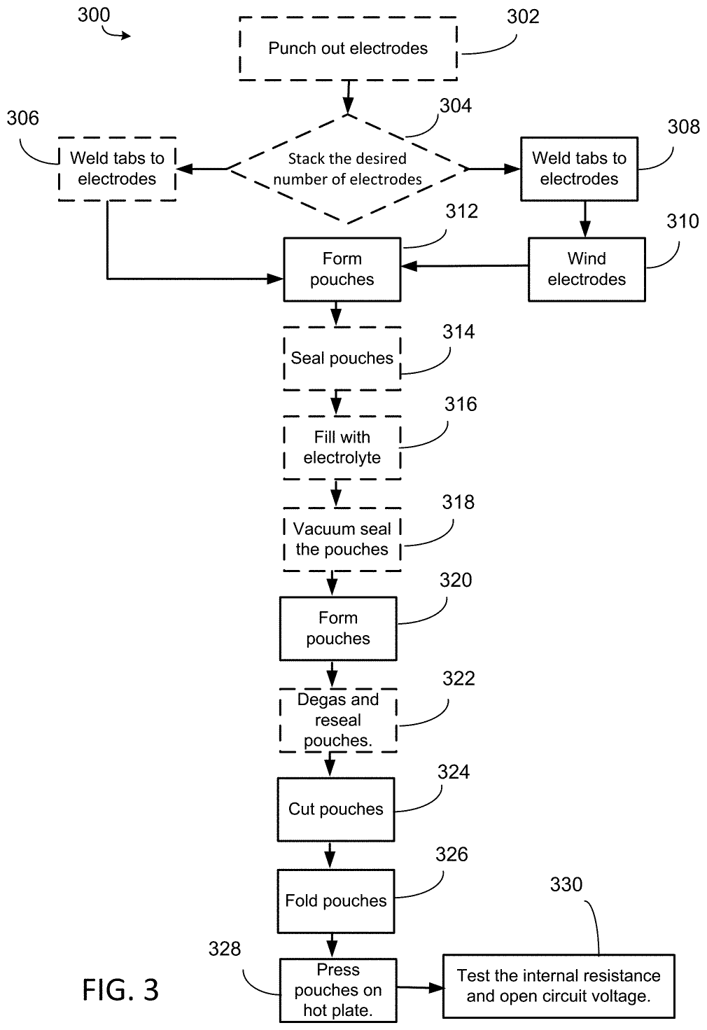

FIG. 3 describes a pouch process flow 300. The dashed lines indicate operations in process flow 300 that are conducted in a dry room. In 302, the electrodes are punched into a desired shape (e.g., rectangular), and in 304 the desired number of electrodes are stacked. In 306 or 308, tabs are welded to the electrodes in a dry room or under atmospheric conditions, respectively. In 310, the electrodes fabricated under atmospheric conditions are wound. In 312, pouches are formed. The pouches are transferred to a dry room and sealed in 314. In 316 and 318, the pouches are filled with electrolyte and vacuum sealed, respectively. In 320, the filled pouches are removed from the dry room and reformed, and in 322 the pouches are returned to the dry room for degassing and resealing. The pouches are removed from the dry room. In 324 and 326, the pouches are cut and folded, respectively, and in 328, the pouches are pressed on a hot plate. In 330, the internal resistance and open circuit voltage of the fabricated pouches are tested.

### EXAMPLE

### Slurry Mixing

Cathode slurry mixing. A poly(vinylidene fluoride) (PVdF) binder solution is prepared by dissolving PVdF in N-methyl-2-pryrrolidone (NMP) in calculated amounts. The PVdF to NMP percentage by weight (wt %) is adjusted (≥5%) depending on coating requirements. A conductive paste is combined with the binder solution and mixed for 1 hour using planetary rotations per minute (RPM) of 5 and disper RPM of 1500. The first half of lithium cobalt oxide (LiCo₂ or LCO) is combined with the mixture and mixed for 1 hour using planetary RPM of 5 and disper RPM of 1500. The second half of LCO is combined with the resulting mixture and mixed for 1 hour using planetary RPM of 5 and disper RPM of 1500 to yield a slurry. The slurry viscosity is adjusted by adding additional NMP as needed. The slurry is mixed vigorously until it is smooth and then defoamed. The viscosity and fineness of the defoamed slurry is assessed. The suggested viscosity for the cathode slurry is 5000-10000 centipoise (cps). Slurry fineness is analyzed by a grind gauge. The size of coarse particles or agglomerates is preferably less than the maximum particle size based on particle distribution analysis (e.g., about 5 microns to about 20 microns).

Anode slurry mixing. A 1.2 wt % solution of carboxymethyl cellulose (CMC) solution is made by dissolving the appropriate amount of CMC into deionized (DI) water. Super-P® (conductive carbon black) is combined with the CMC solution and mixed until smooth and uniform. Graphite and SiOx are dry mixed together in calculated amounts under low speed. The Super-P® CMC solution is added to the dry graphite and SiOx mixture and mixed using planetary RPM of 35. Polyacrylic acid (PAA) binder is added in 2 or 3 batches and the resulting slurry is mixed using planetary RPM of 20-35 for 1 hour after each batch addition. DI water is added to the slurry to obtain a solid content of 35-42 wt %. The slurry is mixed until smooth using planetary RPM of 45 and disper RPM of 2500 (1-2 hours) followed by defoaming. The resulting defoamed slurry quality is assessed by viscosity and fineness. Suggested viscosity for cathode slurry is 2000-3000 centipoise (cps). The slurry fineness is analyzed by a grind gauge. The size of coarse particles or agglomerates is preferably less than the maximum particle size.

### Coating Process

Coating machine preparation. The machine is turned on. All rubber and stainless steel rollers are wiped clean with ethanol, DI water, or acetone, and are blown dry with an air nozzle. Slurry dams and guards are installed so that the coating is located in the center of the current collectors. The residue guard is attached to a comma roll. A connector roll is installed to an unwinder roller. A heater and IR lamp, air inlet fan (2500 RPM), and an exhaust fan (1000 RPM) are turned on. The chambers are allowed to heat to target temperatures for at least 1 hour. For the cathode, the target temperature range is from 85° C. to 140° C. The actual temperature setting depends on the type/structure of the coating machine, coating speed, air flow, and slurry. For the anode, the target temperature range is between 70° C. and 100° C.

Add slurry. The slurry is collected from the mixer while running planetary blades at 5 RPM and filtering if necessary. The viscosity of the slurry is assessed and, if in the targeted range, the slurry is poured to the dam.

Start coating. The unwinder brake and rewinder clutch are turned on. The coating speed is set to 0.7 meters per minute (m/min) for cathode and 0.5 m/min for anode. The tension is adjusted such that the foil is tight but not curling. The foil movement is started and the comma roll and backing nip roll are engaged. The backing roll is moved into contact with the coating roll and coating in initiated.

Check coating. Coatings are checked for smoothness before being placed in the drying chambers. The coatings being removed from the drying chambers are visually inspected to ensure dryness. The coated electrodes are cropped to check the loading level, and the gap between comma roll and coating roll is adjusted accordingly. The coating check is repeated until the target loading level is reached for continuous operation. The temperature, speed, or tension settings are adjusted to ensure the electrodes are dry and without wrinkles. The line and agglomerates are removed by decoupling and recoupling the backing roll with the coating roll.

Finish coating. The coating, line movement, fan, and heater are turned off. The comma roll, backing roll and backing nip are moved out. The power is turned off, and the apparatus is cleaned.

### Calendering Process

Calender preparation. The calender is powered on. The heater is turned on and the upper roll and lower roll control temperatures are allowed to reach 110° C.

Fix electrode. The electrode roll is installed to the unwinder. The electrode is slid through the gap between the two rolls and fixed to the rewinder such that the distance between the electrode edge and the machine edge are the same at both the unwinder and rewinder.

Start calendaring. The two wheels are used to adjust the gap between the two rolls on both sides. The typical gap at 110° C. is 300 μm for anode and 255 μm for anode. Both the unwinder and rewinder tension is set to be 8% and the coating speed is set to 10%. Calendering is initiated. The coating speed is increased to 40% (0.8 m/min) after both the unwinder and rewinder start rotating.

### Notching Process

The machine is turned on. The line of the coating is matched to the line of a jig at both sides. The electrode is put on the jig, and the transparent film is put on the electrode. When the process is finished, and the electrodes are removed. The coating line and the electrode length of the first cut electrode are checked.

### Stacking Process

Alignment of the separators is confirmed. All electrodes are removed. If the separator alignment is acceptable, the process is continued. If the separator alignment is not acceptable, the process is repeated. The stacking machine is turned on, the anode is positioned in a first jig, and the cathode is positioned in a second jig. Stacking begins with anode first. The number of desired anodes is selected. After stacking is complete, the separator is cut. A jelly roll is formed, and the separator is wrapped. The sealing tape is attached to the jelly roll to prevent it from being released.

### Pouch Forming Process

The power is turned, and pouch forming is initiated. The two forming depth bars (1.9 mm) are put in position on the left and right side, respectively. The pouch material sheet aligning the three guidance bars is put in place (polypropylene (PP) layer facing up) and the machine door is closed. The forming process is initiated. After the forming process is finished, the door is opened and the formed pouch is removed. The extra pouch material is cut, and the pouch is folded.

### Pouch Sealing Process

Pouch Tab Sealing. The jelly roll is placed inside the pouch, ensuring that the holes in the pouch match well after folding the pouch. The pouch is placed with the jelly roll in the correct position, with the guidance of the jelly roll protrusion part to fit in the machine, and the holes in the pouch to fit in the two rods in the machine. The cathode and anode sequence is checked for correctness. The press-bar is placed on the top of the pouch to ensure the jelly roll and pouch stay in the correct position during tab sealing. The tab sealing process is initiated. After the tab sealing process is finished, the dry cell is removed.

Pouch Side Sealing. The pouch with the jelly roll is positioned with the guidance of the jelly roll protrusion part in the pouch. The press-bar is placed on the top of the pouch to ensure the jelly roll and pouch stay in the correct position during side sealing. Once the two temperature values reach 180°±3° C., the side sealing process is initiated. After finishing the side sealing process, the dry cell is removed.

Pouch-Tab Impedance Inspection. The impedance between pouch layer and positive tab/negative tab is measured by an ohm meter. This impedance is typically greater than 20 M-ohm for the next process of electrolyte filling.

The dry cell is put in a vacuum oven at 80° C. (176° F.) in dry room (dew point <−40° C.) overnight (>12 hours, ≤31 in Hg).

### Electrolyte Injection Process

Pouch-Tab Impedance Inspection. The impedance between the pouch layer and positive tab/negative tab is measured by an ohm meter. This impedance is typically greater than 20 M-ohm for the next steps of electrolyte filling. The dry cell is placed on the balance shelf with the unsealed pouch side up, and the dry cell weight is measured. The electrolyte is drawn from the electrolyte bottle using a pipette or dropper, and the electrolyte is filled into the dry cell until the electrolyte weight reaches the designed value.

### Vacuum Sealing Process

The extra pouch on the bottom side of dry cell is cut and the dry cell is placed with the filled electrolyte upright in the fixture. When temperature reaches 180°±3° C., the sealing process is initiated. The sealing process goes through a series of vacuum steps, and then the dry cell is sealed.

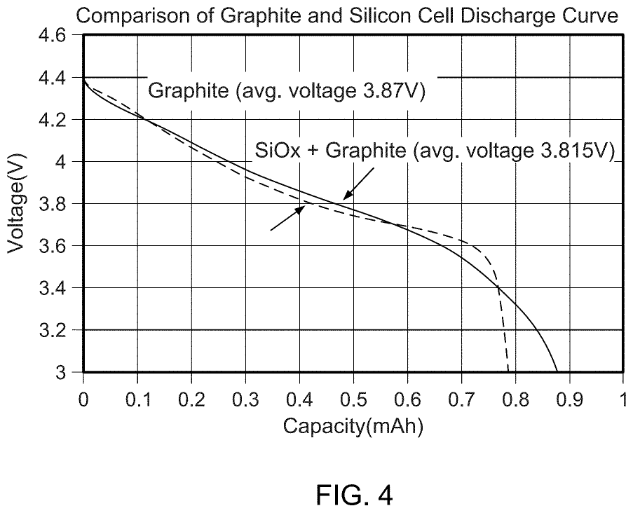

FIG. 4 shows battery discharge voltage by 0.2 C rate to a 3 V cut-off. Batteries using the SiOx+Graphite composite electrodes (solid line) have a lower average voltage (3.815 V), but more capacity below 3.4 V than conventional 4.45 V Li-ion batteries using a graphite only anode (dashed line)

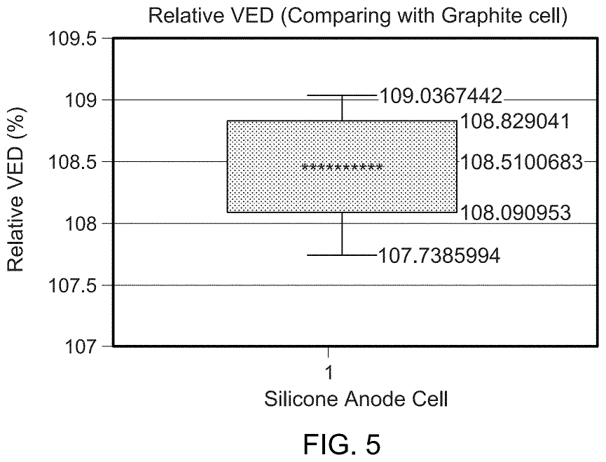

FIG. 5 shows volumetric energy density (VED) of SiOx+Graphite composite electrode batteries relative to conventional 4.45V Li-ion batteries using a graphite only anode. Batteries with the composite electrodes yield 7.7% to 9.0% higher VED (measured in Watt-hours per liter (Wh/L)) compared to batteries with conventional electrodes.

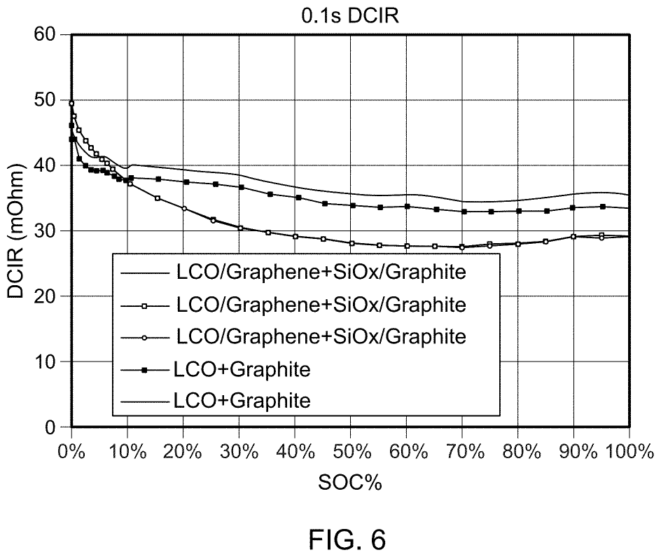

FIG. 6 shows direct current internal resistances (DCIR) under load by 0.1 sec of batteries fabricated with composite electrodes (three lithium cobalt oxide (LCO)/Graphene+SiOx/Graphite compositions) and batteries with conventional electrodes (two LCO+Graphite compositions). The composite electrode batteries have lower DCIR from 10% to 100% state-of-charge (SOC) than the conventional electrode batteries.

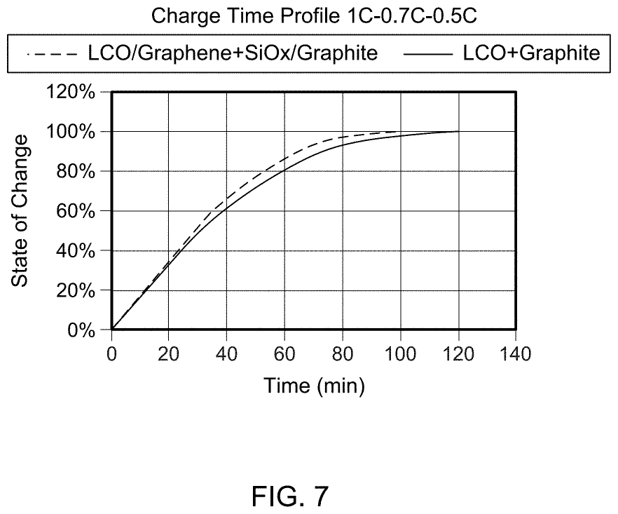

FIG. 7 shows charge time profile for a LCO/Graphene+SiOx/Graphite composite electrode battery and a LCO+Graphite non-composite electrode battery. The composite electrode battery displays a faster charge rate due to its lower DCIR.

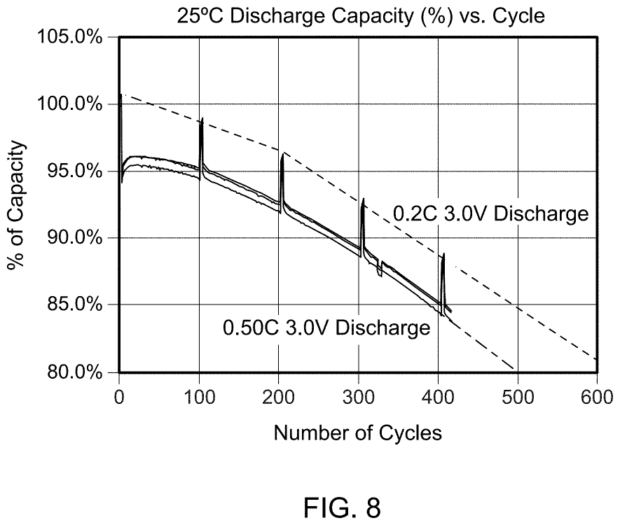

FIG. 8 shows cycle performance of composite electrode batteries at 25 degrees C. The batteries can undergo more than 500 cycles at this temperature.

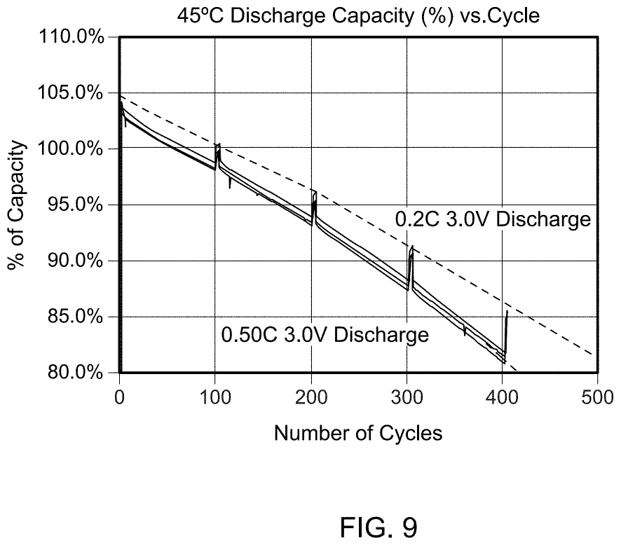

FIG. 9 shows cycle performance of composite electrode batteries at 45 degrees C. The batteries can undergo more than 400 cycles at this temperature.

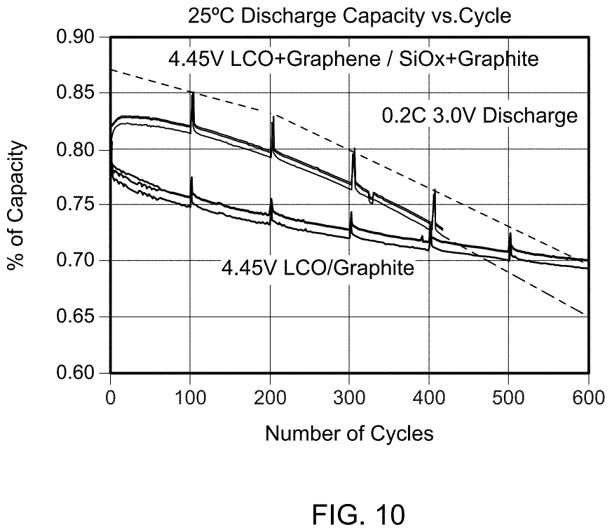

FIG. 10 shows cell cycle performance of composite electrode batteries and conventional 4.45V Li-ion batteries at 25 degrees C. Data from the conventional batteries provide a baseline for comparison. The composite electrode batteries display a higher percent capacity up to 500 cycles compared to the conventional batteries. The dotted line represents an estimate based on the composite electrode data.

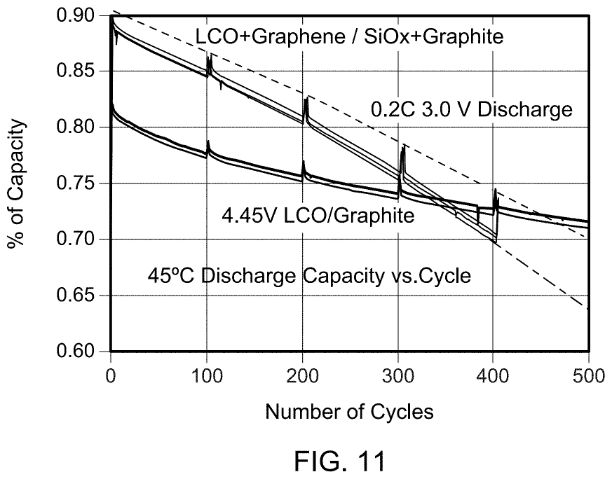

FIG. 11 shows cell cycle performance of composite electrode batteries and conventional 4.45V Li-ion batteries at 45 degrees C. Data from the conventional batteries provide a baseline for comparison. The composite electrode batteries display a higher percent capacity up to 400 cycles compared to conventional batteries. The dotted line represents an estimate bases on the composite electrode data.

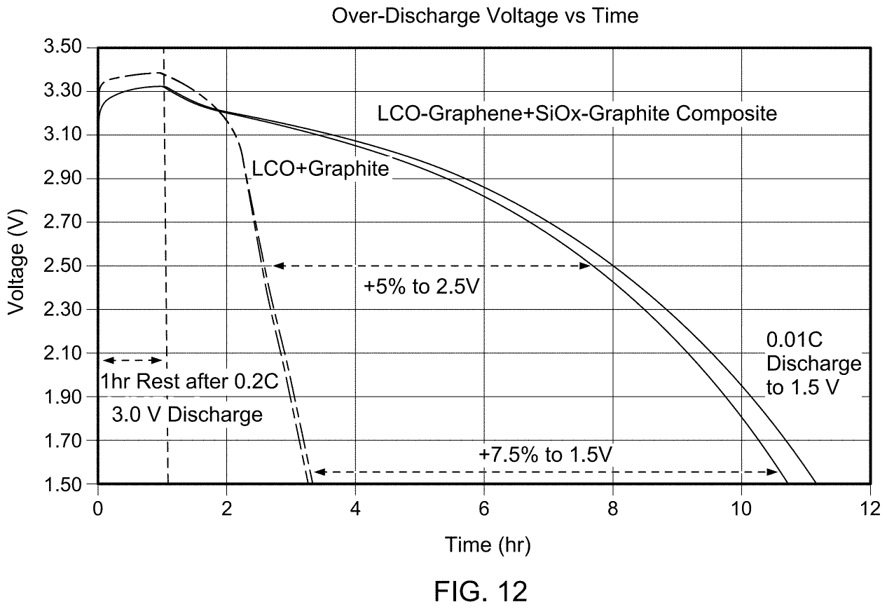

FIG. 12 shows over-discharge-voltage versus time for composite electrode batteries and conventional electrode batteries. Data from the conventional batteries provide a baseline for comparison. The composite electrode batteries provide up to 7.5% more reserved capacity down to 1.5V. This reserved capacity below 3 V provides longer storage times for wearable devices.

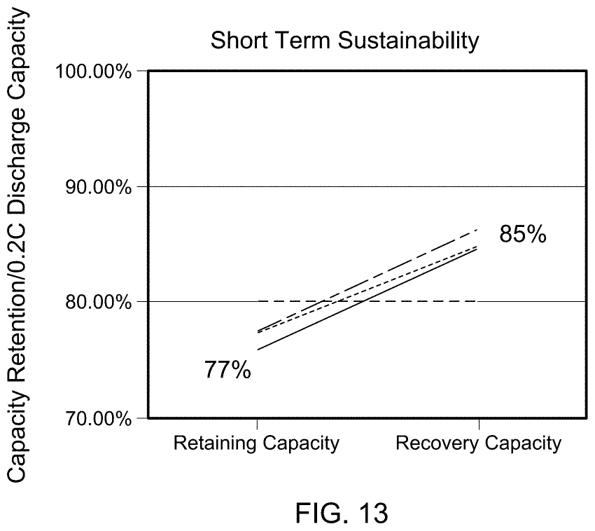

FIG. 13 shows the retaining capacity and recovery capacity of three composite electrode batteries at elevated temperature (85 degrees C.).

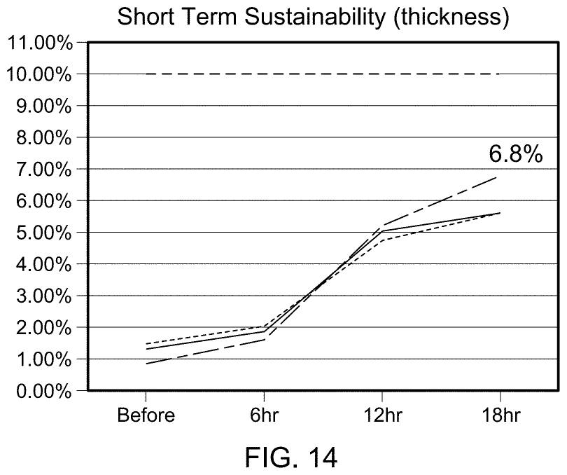

FIG. 14 shows the short term sustainability of three composite electrode batteries as a function of time.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A lithium ion battery comprising:
an anode comprising an anode collector and a composite anode material comprising 75 wt % to 95 wt % graphite, 2 wt % to 20 wt % SiOx, 0.1 wt % to 10 wt % binder, and 0.1 wt % to 10 wt % conductive additive;
a cathode comprising a cathode collector and a composite cathode material comprising LiCoO₂, one or both of graphene and carbon nanostructures, and a binder;
a separator positioned between the anode and the cathode; and
an electrolyte in contact with the anode and the cathode.

2. (canceled)

3. (canceled)

4. The lithium ion battery of claim 1, wherein the composite anode material comprises 80 wt % to 90 wt % graphite, 5 wt % to 10 wt % SiOx, 0.1 wt % to 5 wt % binder, and 0.1 wt % to 2 wt % conductive additive.

5. The lithium ion battery of claim 1, wherein the composite anode material comprises 86 wt % to 87 wt % graphite, 9 wt % to 10 wt % SiOx, 2 wt % to 3 wt % binder, and 0.5 wt % to 1.5 wt % conductive additive, and the binder is a mixture of carboxymethyl cellulose (CMC) and polyacrylic acid (PAA) in a weight ratio of about 1 to 4.

6. The lithium ion battery of claim 5, wherein the composite anode material comprises 86.7 wt % graphite, 9.6 wt % SiOx, 2.7 wt % binder, and 1 wt % conductive additive, and the binder is a mixture carboxymethyl cellulose (CMC) and polyacrylic acid (PAA) in a weight ratio of 0.5:2.2.

7-9. (canceled)

10. The lithium ion battery of claim 1, wherein the composite anode material comprises 85 wt % to 95 wt % graphite, 1 wt % to 10 wt % SiOx, 0.1 wt % to 5 wt % binder, and 0.1 wt % to 2 wt % conductive additive.

11. (canceled)

12. (canceled)

13. A lithium ion battery comprising:
an anode comprising an anode collector and a composite anode material comprising graphite, SiOx, and a binder;
a cathode comprising a cathode collector and a composite cathode material comprising 90 wt % to 99 wt % LiCoO₂, 0.1 wt % to 2 wt % binder, and 0.1 wt % to 2 wt % of one or both of graphene and carbon nanostructures or a combination thereof;
a separator positioned between the anode and the cathode; and
an electrolyte in contact with the anode and the cathode.

14. (canceled)

15. (canceled)

16. The lithium ion battery of claim 13, wherein the composite cathode material comprises 95 wt % to 99 wt % LiCoO₂, 1 wt % to 2 wt % binder, and 0.1 wt % to 1 wt % graphene, carbon nanostructures, or a combination thereof.

17. The lithium ion battery of claim 16, wherein the composite cathode material comprises 97 wt % to 98 wt % LiCoO₂, 1 wt % to 2 wt % binder, and 0.56 wt % graphene paste, carbon nanostructures, or a combination thereof.

18-21. (canceled)

22. A lithium ion battery comprising:
an anode comprising an anode collector and a composite anode material comprising graphite, SiOₓ, and a binder;
a cathode comprising a cathode collector and a composite cathode material comprising LiCoO₂, one or both of graphene and carbon nanostructures, and a binder;
a separator positioned between the anode and the cathode; and
an electrolyte in contact with the anode and the cathode, wherein the electrolyte is a liquid organic solvent-based electrolyte comprising one or more of fluoroethylene carbonate (FEC), propylene carbonate (PC), diethyl carbonate (DC), ethylene carbonate (EC), and polypropylene (PP) in a lithium hexafluorophosphate (LiPF₆) solution comprising one or more of adiponitrile (ADN), succinonitrile (SN), 1,3-propane sultone (PS), and vinylene carbonate (VC).

23. The lithium ion battery of claim 22, wherein the electrolyte further comprises one or more organosilicon additives.

24. The lithium ion battery of claim 22, wherein the electrolyte comprises 0 vol % to 20 vol % fluoroethylene carbonate (FEC), 0 vol % to 20 vol % propylene carbonate (PC), 0 vol % to 40 vol % ethylene carbonate (EC), 0 vol % to 40 vol diethyl carbonate (DC), and 0 vol % to 50 vol % polypropylene (PP).

25. The lithium ion battery of claim 22, wherein the LiPF₆ solution has a concentration in a range of 0.1M to 5M.

26. The lithium ion battery of claim 22, wherein the LiPF₆ solution comprises 0.1 wt % to 5 wt % of one or more of adiponitrile (ADN), succinonitrile (SN), 1,3-propane sultone (PS), vinylene carbonate (VC), and organosilicon additive.

27. The lithium ion battery of claim 22, wherein the electrolyte comprises fluoroethylene carbonate (FEC), propylene carbonate (PC), diethyl carbonate (DC), ethylene carbonate (EC), and polypropylene (PP) in a LiPF₆ solution comprising adiponitrile (ADN), succinonitrile (SN), 1,3-propane sultone (PS), vinylene carbonate (VC), and organosilicon additive.

28. (canceled)

29. The lithium ion battery of claim 27, wherein the electrolyte comprises 5 vol % to 10 vol % fluoroethylene carbonate (FEC), 5 vol % to 15 vol % propylene carbonate (PC), 15 vol % to 25 vol % ethylene carbonate (EC), 20 vol % to 30 vol % diethyl carbonate (DC), and 30 vol % to 40 vol % polypropylene (PP).

30. The lithium ion battery of claim 27, wherein the electrolyte comprises 5 vol % to 10 vol % fluoroethylene carbonate (FEC), 5 vol % to 10 vol % propylene carbonate (PC), 15 vol % to 20 vol % ethylene carbonate (EC), 25 vol % to 30 vol % diethyl carbonate (DC), and 35 vol % to 40 vol % polypropylene (PP).

31. The lithium ion battery of claim 27, wherein the electrolyte comprises 6 vol % to 8 vol % fluoroethylene carbonate (FEC), 8 vol % to 10 vol % propylene carbonate (PC), 18 vol % to 20 vol % ethylene carbonate (EC), 27 vol % to 29 vol % diethyl carbonate (DC), and 36 vol % to 38 vol % polypropylene (PP).

32. The lithium ion battery of claim 31, wherein the electrolyte comprises 7 vol % fluoroethylene carbonate (FEC), 9 vol % propylene carbonate (PC), 19 vol % ethylene carbonate (EC), 28 vol % diethyl carbonate (DC), and 37 vol % polypropylene (PP).

33-35. (canceled)

36. The lithium ion battery of claim 27, wherein the electrolyte comprises 1 vol % to 10 vol % fluoroethylene carbonate (FEC), 5 vol % to 15 vol % propylene carbonate (PC), 15 vol % to 25 vol % ethylene carbonate (EC), 25 vol % to 35 vol % diethyl carbonate (DC), and 30 vol % to 40 vol % polypropylene (PP).

37. (canceled)

38. (canceled)

39. The lithium ion battery of claim 26, wherein the LiPF₆ solution has a concentration in a range of 0.5M to 1.5M and comprises 0.1 wt % to 5 wt % adiponitrile (ADN), 0.1 wt % to 5 wt % succinonitrile (SN), 0.1 wt % to 5 wt % 1,3-propane sultone (PS), 0.1 wt % to 5 wt % vinylene carbonate (VC), and 0.1 wt % to 5 wt % organosilicon additive.

40. The lithium ion battery of claim 39, wherein the LiPF₆ solution has a concentration in a range of 0.5M to 1.5M and comprises 0.5 wt % to 1.5 wt % adiponitrile (ADN), 0.5 wt % to 1.5 wt % succinonitrile (SN), 1 wt % to 3 wt % 1,3-propane sultone (PS), 0.5 wt % to 1.5 wt % vinylene carbonate (VC), and 1 wt % to 3 wt % organosilicon additive.

41. The lithium ion battery of claim 40, wherein the LiPF₆ solution has a concentration of 1M and comprises 1 wt % adiponitrile (ADN), 1 wt % succinonitrile (SN), 2 wt % 1,3-propane sultone (PS), 1 wt % vinylene carbonate (VC), and 2 wt % organosilicon additive.

42. The lithium ion battery of claim 26, wherein the LiPF₆ solution has a concentration in a range of 0.5M to 1.5M and comprises 1 wt % to 3 wt % adiponitrile (ADN), 1 wt % to 3 wt % succinonitrile (SN), 2 wt % to 4 wt % 1,3-propane sultone (PS), 0.5 wt % to 1.5 wt % vinylene carbonate (VC), and 1 wt % to 3 wt % organosilicon additive.

43-46. (canceled)
